(19) United States
(12) Patent Application Publication
(10) Pub. No.: US 2025/0060301 A1
(43) Pub. Date: Feb. 20, 2025

(54) FLOW CYTOMETER, DISCRIMINATION METHOD, AND PROGRAM

(71) Applicant: ThinkCyte K.K., Tokyo (JP)

(72) Inventors: Toru Imai, Tokyo (JP); Keisuke Toda, Tokyo (JP)

(73) Assignee: ThinkCyte K.K., Tokyo (JP)

(21) Appl. No.: 18/915,034

(22) Filed: Oct. 14, 2024

Related U.S. Application Data
(63) Continuation of application No. PCT/JP2023/014723, filed on Apr. 11, 2023.

(30) Foreign Application Priority Data
Apr. 15, 2022 (JP) 2022-067776

(51) Int. Cl. G01N 15/14; G01N 15/10; G01N 15/1433; G01N 15/1434

(52) U.S. Cl. CPC G01N 15/1459; G01N 15/1433; G01N 15/1434; G01N 2015/1006

(57) ABSTRACT

A flow cytometer includes: a flow channel allowing a measurement object not labeled with a fluorescent dye to flow along with a fluid; a light source emitting illumination light; an illumination optical system irradiating the measurement object flowing in the flow channel with the illumination light emitted from the light source as a spotlight which is illumination light condensed in at least one of a width direction and a depth direction of the flow channel at an irradiation position in the flow channel; a light detector detecting fluorescence emitted from a specific molecule of the measurement object in response to irradiation with the spotlight via the illumination optical system; a detection optical system allowing the fluorescence to propagate to the light detector; and a discrimination unit configured to discriminate whether the measurement object is a target measurement object based on information of the fluorescence detected by the light detector.

Priority is claimed on Japanese Patent Application No. 2022-067776, filed Apr. 15, 2022, the content of which is incorporated herein by reference.

### TECHNICAL FIELD

The present invention relates to a flow cytometer, a discrimination method, and a program.

### BACKGROUND ART

It is known that observation using autofluorescence works as a useful diagnostic indicator in observation using a microscope or an endoscope. For example, it is known that diagnosis of a tissue structure, the condition of a disease (canceration status), and the like is noninvasively performed from a change of an autofluorescence spectrum of tissue in fluorescence diagnosis (Non-Patent Documents 1 and 2). It is also known that observation using autofluorescence is useful for observation of a specific phenomenon in a cell.

For example, by the endoscopic observation using autofluorescence, an application example is known in which cancer tissue or micro cancer, which is difficult to find using a conventional endoscope, is detected. In addition, a method of analyzing an intrinsic fluorescence of single cell using a confocal microscope is known. In the method, positional and morphological information of a cell is acquired using a reflecting microscope method, autofluorescence information of the cell is acquired using a confocal laser microscope method to perform image analysis for each cell, and autofluorescence information of each cell is reconstructed as an autofluorescence signature (Patent Document 1). It is also known that an activated T cell can be separated and identified by autofluorescence imaging (Non-Patent Documents 3 and 4).

On the other hand, with the progress of regenerative medicine using stem cells such as iPS cells or immunotherapy using CART, there is a strong demand for flow cytometry technology capable of performing high-speed single-cell analysis for a large amount of cells particularly in the field of healthcare such as drug discovery. In measurement using a flow cytometer, information such as an amount of protein expressed in a cell needs to be read from cells, which are measurement objects flowing in a flow channel, with a high sensitivity in a short time. Therefore, a method of labeling measurement objects with ag fluorescent label and then measuring the measurement objects has been used more widely. In this method, a dye emitting fluorescence (such as an antibody labeled with fluorescence) is added to a measurement sample in order to visualize a specific structure of the cells, which are measurement objects, and the cells are functionally observed.

In the measurements with a flow cytometer using an antibody labeled with a fluorescent dye, an autofluorescence signal derived from a living body becomes background noise which interferes with detection of a fluorescence signal derived from the marker substance of interest. Furthermore, leakage of an autofluorescence signal into another channel also becomes an obstructive factor which hides a signal derived from a specific protein with a low expression level. Accordingly, in the measurement with a flow cytometer using an antibody labeled with a fluorescent dye, autofluorescence of measurement objects becomes a factor interfering with the measurement using fluorescence labeling, and thus the measurement has been performed while taking measures to minimize the influence of the autofluorescence.

In this way, in the conventional flow cytometers, great efforts have been made in view of how autofluorescence derived from cells is curbed to prevent background noise, and measurement using autofluorescence of measurement objects has not been carried out. As in the above-mentioned observation using a microscope or an endoscope, if measurement using autofluorescence of cells can be performed even in a flow cytometer, it can be expected to noninvasively identify a cell condition or a specific type of cells without labeling the cells with a fluorescent dye. However, it is difficult to measure autofluorescence from the cells moving in a flow channel in the flow cytometer with a sensitivity and accuracy required for their discrimination in a short time.

### CITATION LIST

### Patent Document

### Patent Document 1:

WO 2018/117273

### Non-Patent Documents

### Non-Patent Document 1:

“Fluorescence diagnosis,” [online], Kokyo, Inc., [retrieved on Dec. 20, 2021], Internet <URL: https://optipediainfo/laser/handbook/laser-handbook-9th-section/38-6/>

### Non-Patent Document 2:

“AUTOFLUORESCENCE IMAGING,” [online], THE UNIVERSITY OF COLUMBIA, [retrieved on Dec. 20, 2021], Internet <URL: https://ophthalmology.med.ubc.ca/patient-care/ophthalmic-photography/autofluorescence-imaging/>

### Non-Patent Document 3:

“NATURE BIOMEDICAL ENGINEERING,” Jul. 27, 2020, Volume 5, p. 77-88.

### Non-Patent Document 4:

“JOURNAL OF BIOPHOTONICS,” Oct. 29, 2019, Volume 13, No. 3.

### SUMMARY OF THE INVENTION

### Technical Problem

Autofluorescence derived from a cell has a weak intensity, and the measurement sensitivity thereof becomes lower than that of a fluorescence signal derived from a marker material. In a microscope or an endoscope, a measurement object is fixed and the fixed measurement object is observed. Therefore, in a microscope or an endoscope, it can increase an SN ratio (a signal-noise ratio) and improve the observation sensitivity by setting a sufficiently long measurement time. On the other hand, in a flow cytometer, since a cell which is a measurement object moves in a flow channel unlike a microscope or an endoscope, an approach of enhancing sensitivity by setting an observation time to be longer cannot be taken. Accordingly, it has been thought to be difficult in the flow cytometer to measure a signal derived from autofluorescence emitted from a measurement object moving in a flow channel with an SN ratio by which a sensitivity and accuracy required for discriminating the measurement object can be obtained.

However, there is a strong demand especially in the field of healthcare such as drug discovery for rapidly and noninvasively performing single-cell analysis and accurately acquiring only target cells in which a specific phenomenon is expressed. Accordingly, it is expected to be able to discriminate measurement objects based on their autofluorescence even in measurement using a flow cytometer.

The present invention has been made in consideration of the aforementioned circumstances and provides a flow cytometer, a discrimination method, and a program that can discriminate measurement objects based on their autofluorescence in the measurement using the flow cytometer.

### Solution to Problem

In order to achieve the aforementioned objective, an aspect of the present invention provides a flow cytometer including: a flow channel allowing a measurement object not labeled with a fluorescent dye to flow along with a fluid; a light source emitting illumination light; an illumination optical system irradiating the measurement object flowing in the flow channel with a spotlight which is illumination light emitted from the light source is condensed in at least one of a width direction and a depth direction of the flow channel at an irradiation position in the flow channel; a light detector detecting fluorescence emitted from a specific molecule of the measurement object in response to irradiation with the spotlight via the illumination optical system; a detection optical system allowing the fluorescence to propagate to the light detector; and a discrimination unit configured to discriminate whether the measurement object is a target measurement object based on information of the fluorescence detected by the light detector.

In the flow cytometer according to the aspect of the present invention, the illumination optical system irradiates the measurement object flowing in the flow channel with the spotlight by condensing the illumination light emitted from the light source to the size of the measurement object at the irradiation position.

The flow cytometer according to the aspect of the present invention further includes a focusing mechanism configured to cause a sample flow of the measurement object flowing in the flow channel to converge to a predetermined range in the width direction of the flow channel, and the illumination optical system sets a ratio of a width of the spotlight to a width of the flow channel to be equal to or less than a predetermined ratio and irradiates the measurement object with the spotlight at the irradiation position.

The flow cytometer according to the aspect of the present invention further includes a focusing mechanism configured to cause a sample flow of the measurement object flowing in the flow channel to converge to a predetermined range in the depth direction of the flow channel, and the illumination optical system condenses the spotlight into a specific position in the depth direction of the flow channel and irradiates the measurement object with the spotlight at the irradiation position.

In the flow cytometer according to the aspect of the present invention, the flow channel allows the measurement object to flow along with a fluid at a speed less than a predetermined speed.

In the flow cytometer according to the aspect of the present invention, the detection optical system separates the fluorescence into spectrum components, the light detector detects each spectrum component of the fluorescence which is separated into the spectrum components by the detection optical system, and the discrimination unit performs the discrimination of the measurement object based on spectrum information which is information of the spectrum components of the fluorescence detected by the light detector.

The flow cytometer according to the aspect of the present invention further includes a learning unit configured to generate a trained model for discriminating whether the measurement object is the target measurement object when the spectrum information on the measurement object is input, and the discrimination unit performs the discrimination of the measurement object based on the spectrum information of the measurement object using the trained model.

In the flow cytometer according to the aspect of the present invention, the learning unit generates the trained model by performing machine learning using training data in which the information of the spectrum components detected by the light detector and information for identifying the target measurement object are combined for a training sample including the target measurement objects and measurement objects other than the target measurement objects as the measurement objects, and the discrimination unit performs the discrimination of the measurement object based on the trained model generated by the learning unit and information of the spectrum components detected by the light detector for the measurement object flowing in the flow channel.

In the flow cytometer according to the aspect of the present invention, at least one of the illumination optical system and the detection optical system includes a spatial light modulator, the light detector detects the fluorescence as a dynamic ghost imaging signal, and the discrimination unit performs the discrimination of the measurement object using morphological information with a higher resolution than a predetermined resolution out of morphological information of the measurement object included in the dynamic ghost imaging signal.

The flow cytometer according to the aspect of the present invention further includes a learning unit configured to generate a trained model for discriminating whether the measurement object is the target measurement object when the dynamic ghost imaging signal for the measurement object is input, and the discrimination unit performs the discrimination of the measurement object based on the dynamic ghost imaging signal for the measurement object using the trained model.

Another aspect of the present invention provides a discrimination method of discriminating a measurement object based on a result detected by a flow cytometer including: a flow channel allowing a measurement object not labeled with a fluorescent dye to flow along with a fluid; a light source emitting illumination light; an illumination optical system irradiating the measurement object flowing in the flow channel with the illumination light emitted from the light source as a spotlight which is illumination light condensed in at least one of a width direction and a depth direction of the flow channel at an irradiation position in the flow channel; a light detector detecting fluorescence emitted from a specific molecule of the measurement object in response to irradiation with the spotlight via the illumination optical system; and a detection optical system allowing the fluorescence to propagate to the light detector, the discrimination method including: an acquisition step of acquiring data indicating an intensity of the fluorescence detected by the light detector for the measurement object flowing in the flow channel; a generation step of generating information of the fluorescence based on the data acquired in the acquisition step; and a discrimination step of discriminating whether the measurement object is a target measurement object based on the information of the fluorescence generated in the generation step.

Another aspect of the present invention provides a program causing a computer to perform information processing based on a result detected by a flow cytometer including: a flow channel allowing a measurement object not labeled with a fluorescent dye to flow along with a fluid; a light source emitting illumination light; an illumination optical system irradiating the measurement object flowing in the flow channel with the illumination light emitted from the light source as a spotlight which is illumination light condensed in at least one of a width direction and a depth direction of the flow channel at an irradiation position in the flow channel; a light detector detecting fluorescence emitted from a specific molecule of the measurement object in response to irradiation with the spotlight via the illumination optical system; and a detection optical system allowing the fluorescence to propagate to the light detector, the computer performing: an acquisition step of acquiring data indicating an intensity of the fluorescence detected by the light detector for the measurement object flowing in the flow channel; a generation step of generating information of the fluorescence based on the data acquired in the acquisition step; and a discrimination step of discriminating whether the measurement object is a target measurement object based on the information of the fluorescence.

### Advantageous Effects of the Invention

According to the present invention, it is possible to discriminate a measurement object based on autofluorescence in measurement using a flow cytometer.

### BRIEF DESCRIPTION OF THE DRAWINGS

FIG. 1 is a diagram illustrating an example of a configuration of a flow cytometer according to a first embodiment of the present invention.

FIG. 2A and FIG. 2B are diagrams illustrating an example of a shape of illumination light (a spotlight) at an irradiation position in the flow cytometer according to the first embodiment of the present invention.

FIG. 3A and FIG. 3B are diagrams illustrating an example of a shape of illumination light at an irradiation position in a conventional flow cytometer.

FIG. 4 is a diagram illustrating an example of a time-series waveform of fluorescence intensities detected by the conventional flow cytometer.

FIG. 5 is a diagram illustrating an example of a time-series waveform of fluorescence intensities detected by the flow cytometer according to the first embodiment of the present invention.

FIG. 6 is a diagram illustrating an example of a configuration of an information processing device according to the first embodiment of the present invention.

FIG. 7 is a diagram illustrating an example of a discrimination process according to the first embodiment of the present invention.

FIG. 8 is a diagram illustrating an example of a shape of a spotlight according to a modified example of the first embodiment of the present invention.

FIG. 9 is a diagram illustrating an example of a configuration of a flow cytometer according to a second embodiment of the present invention.

FIG. 10 is a diagram illustrating an example of a configuration of a flow cytometer according to a third embodiment of the present invention.

FIG. 11 is a diagram illustrating clusters of measurement results according to examples of the present invention.

FIG. 12 is a diagram illustrating a method for discriminating between lymphocytes according to examples of the present invention.

### DESCRIPTION OF THE EMBODIMENTS

### First Embodiment

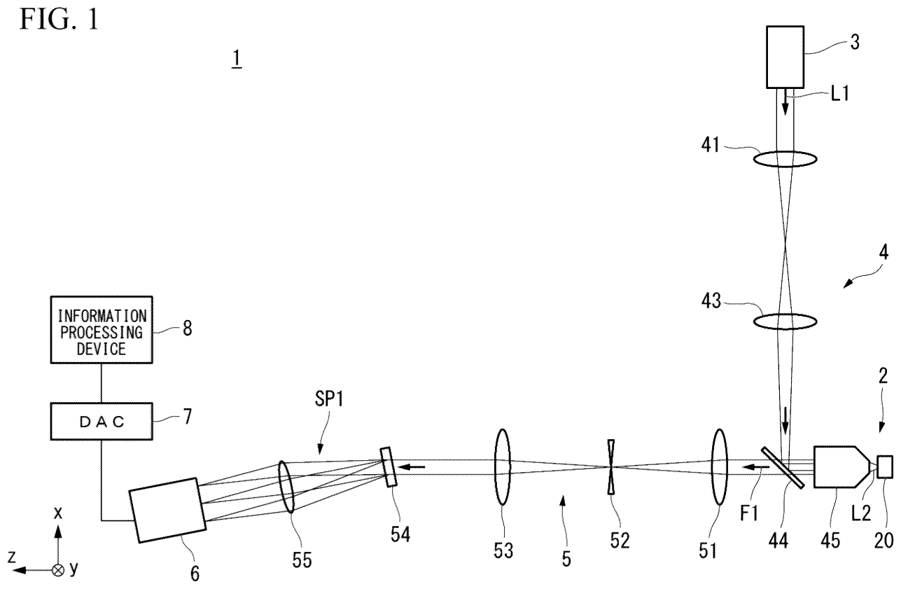

Hereinafter, an embodiment of the present invention will be described in detail with reference to the accompanying drawings. FIG. 1 is a diagram illustrating an example of a configuration of a flow cytometer 1 according to a first embodiment of the present invention. The flow cytometer 1 includes a microfluidic device 2, a light source 3, an illumination optical system 4, a detection optical system 5, a light detector 6, a DAC 7, and an information processing device 8.

The microfluidic device 2 includes a flow channel 20 and a focusing mechanism 21 (not illustrated). The flow channel 20 allows a cell C1 to flow along with a fluid. The flow channel 20 allows a cell C1 to flow along with a fluid at a speed lower than a predetermined speed. A flow speed of the fluid flowing in the flow channel 20 is, for example, lower than a flow speed which is used in a conventional flow cytometer. In this embodiment, the flow speed of the fluid flowing in the flow channel 20 is, for example, lower than 5 m/s.

In conventional flow cytometers, increasing a flow speed of a fluid flowing in the flow channel is often attempted to realize requirements for rapid analysis. In the microfluidic device 2 according to this embodiment, the cell C1 can be allowed to flow along with a fluid at the same speed as the flow speed used in the conventional flow cytometer. Accordingly, the flow speed of the fluid flowing in the flow channel 20 of the microfluidic device 2 may be equal to or higher than a predetermined speed. Here, for the purpose of sensitively detecting autofluorescence emitted from the cell C1, it is preferable that a flow speed of a fluid flowing in the flow channel 20 be lower than the flow speed used for high-speed analysis in the conventional flow cytometer.

In the microfluidic device 2, a plurality of cells are allowed to flow sequentially in the flow channel 20, and the number of cells flowing at an irradiation position of the flow channel 20 at a time is one.

The cell C1 is not labeled with a fluorescent dye. The cell C1 is an example of a measurement object which is not labeled with a fluorescent dye. The measurement object is not limited to the cell C1. It may be, for example, a spheroid (a cell cluster), fine particles, or microorganisms. The fine particles include fine particles such as pollen, microplastics, lipidic particles, or polymer particles (for example, flow cytometer correction particles). The microorganisms include germs, funguses, viruses, or protozoans.

In measurement in the flow cytometer, a method of labeling a measurement object with a fluorescent dye and measuring the measurement object is widely used, but the cell C1 is not labeled with a fluorescent dye. The fluorescent dye is not particularly limited as long as it is a dye emitting fluorescence, and examples thereof include fluorescent dyes or fluorescent probes such as FITC (Fluorescein Isothiocyanate), Auramine O, Auramine O/Rhodamine B, Acridine orange, DAPI (4′,6-diamino-2-phenylindole), SYBR Green I, Cy carboxylic acid such as Cy3 or Cy5, Texas Red, or ethidium bromide.

A labeling method using a fluorescent dye includes a method of staining a specific component of the cell C1 with a fluorescent dye or a method of labeling by reacting the cell C1 with a fluorescent-labeled antibody, gene, lectin, or the like. The cell C1 may be labeled using fluorescent protein such as green fluorescent protein (GFP) or luciferase as a fluorescent dye. The cell C1 is a cell that is not labeled with such a fluorescent dye and is a cell that is not fluorescently labeled through artificial processing.

In the drawing, an xyz coordinate system is illustrated as a three-dimensional orthogonal coordinate system. In this embodiment, an x-axis direction is a width direction of the flow channel 20. A y-axis direction is a length direction of the flow channel 20. A z-axis direction is a height or depth direction of the flow channel 20 which is perpendicular to the flow channel 20. A flow of a fluid in the flow channel 20 moves the cell C1 to the +y side in the y-axis direction. In other words, the width direction of the flow channel 20 is a direction perpendicular to a flow direction of the fluid flowing along with the cell C1.

The focusing mechanism 21 causes the cells C1 in the flow channel 20 to flow as a more focused and narrowed laminar flow. For example, the focusing mechanism 21 causes a flow of the cells C1 flowing in the flow channel 20 to converge to a predetermined range in the width direction of the flow channel 20. The focusing mechanism 21 causes the flow of the cells C1 flowing in the flow channel 20 to converge to a predetermined range in the depth direction of the flow channel 20. That is, the focusing mechanism 21 is a mechanism for narrowing the flow of the cells C1 in the flow channel 20. By the focusing mechanism 21, the cells C1 are caused to converge and flow within a predetermined range in the flow channel 20. In the following description, the flow of the cell C1 in the flow channel 20 may be simply referred to as a sample flow.

The focusing mechanism 21 is a mechanism for narrowing the sample flow (decreasing a cross-sectional area through which the cell C1 flows in a cross-section perpendicular to the flow of the fluid in the flow channel 20) using a method such as hydrodynamic focusing or acoustic focusing. Hydrodynamic focusing is a technique of arranging measurement objects in a line of an axis and moving them substantially at the same speed by arranging a sheath liquid to surround the flow of the measurement objects such as cells. In the hydrodynamic focusing, the sample flow in the flow channel 20 can be narrowed to a specific position in the flow channel 20 by adding a sheath liquid to the sample flow in a lateral direction or a vertical direction. Acoustic focusing is a technique of narrowing the sample flow using acoustics (ultrasonic waves).

The focusing mechanism 21 may use both hydrodynamic focusing and acoustic focusing. In addition to the above, a method of narrowing a sample flow in a flow channel using a technique such as dielectrophoresis or inertial focusing has been reported, and the focusing mechanism 21 may employ this technique. In the following description, the case in which cells, which are measurement objects, are narrowed to the central position of the flow channel 20 by the focusing mechanism 21 is mainly explained, but the position at which the sample flow is narrowed by the focusing mechanism 21 is not limited thereto. The focusing mechanism 21 can narrow a sample flow at a desired specific position in the flow channel 20 according to settings thereof.

The light source 3 emits illumination light L1. The light source 3 is, for example, a laser light source. The light source 3 may be a light source such as an LED light source. The illumination light L1 is single-wavelength light. A peak wavelength of the illumination light L1 is preferably in a range of 350 nm to 500 nm.

The light source 3 includes, for example, a single light source. As will be described later, the light source 3 may include a plurality of light sources. Wavelengths of illumination light emitted from the plurality of light sources are preferably in a range of 350 nm to 500 nm similarly to the illumination light L1.

The illumination optical system 4 is an optical mechanism for irradiating a cell C flowing in the flow channel 20 with the illumination light L1 emitted from the light source 3 and includes a plurality of optical elements. In FIG. 1, the illumination optical system 4 includes a first lens 41, a second lens 43, a dichroic mirror 44, and an objective lens 45. The first lens 41, the second lens 43, the dichroic mirror 44, and the objective lens 45 are arranged on an optical path between the light source 3 and the flow channel 20 sequentially from a side closest to the light source 3. The illumination optical system 4 is not limited to the configuration illustrated in FIG. 1.

The first lens 41 condenses illumination light L1 emitted from the light source 3.

The second lens 43 makes the illumination light L1 condensed by the first lens 41 into parallel light. In the example illustrated in FIG. 1, the first lens 41 and the second lens 43 are both convex lenses. A focal distance of the second lens 43 is larger than a focal distance of the first lens 41. For example, the first lens 41 may be formed of a concave lens and the second lens 43 may be formed of a convex lens. A beam expander which is commercially available may be used instead of the lenses. By the first lens 41 and the second lens 43, the illumination light L1 is incident on the dichroic mirror 44 as parallel light which is more uniformly spread.

The dichroic mirror 44 reflects the parallelized illumination light L1 emitted from the second lens 43. The dichroic mirror 44 causes the reflected illumination light L1 to be incident on the objective lens 45.

The objective lens 45 condenses the illumination light L1 reflected by the dichroic mirror 44 and irradiates the irradiation position of the flow channel 20 with a spotlight L2. When the irradiation position of the flow channel 20 is irradiated with the spotlight L2 by the objective lens 45, the illumination optical system 4 irradiates the irradiation position with the spotlight L2. The objective lens 45 may be a dry objective lens or an immersion objective lens. The immersion objective lens includes an oil-immersion lens or a water-immersion lens.

The illumination light L1 emitted from the light source 3 is irradiated to the cell 1 flowing in the flow channel 20 as the spotlight L2 through the illumination optical system 4. The spotlight L2 is illumination light obtained by condensing the illumination light L1 on the irradiation position of the flow channel 20. The illumination optical system 4 condenses the illumination light L1 at the irradiation position in the flow channel 20 in both the width direction and the depth direction of the flow channel 20 to irradiate a cell C1 flowing in the flow channel 20 as the spotlight L2.

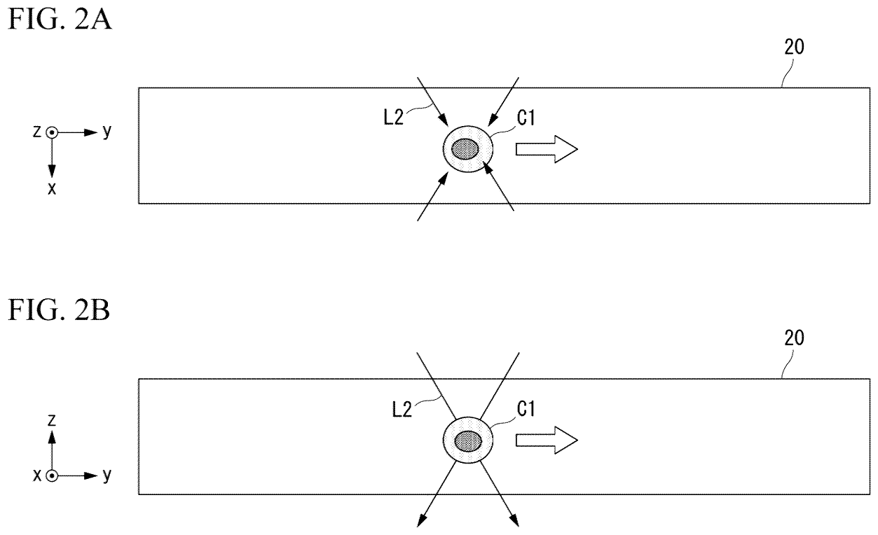

The condensed illumination light L1 (spotlight L2) will be described below with reference to FIG. 2.

FIG. 2 is a diagram illustrating an example of a shape of the illumination light L1 (spotlight L2) at an irradiation position in the flow cytometer according to this embodiment. In FIG. 2, for example, a cell C1 passes through the vicinity of the center of the flow channel in the width direction of the flow channel 20. Passing of the cell C1 through the center of the flow channel 20 means that the center of a sample flow of the cells C1 flowing in the flow channel 20 passes through the vicinity of the center of the flow channel 20. In FIG. 2, the cell C1 passes through the vicinity of a specific position of the flow channel 20 in the depth direction of the flow channel 20. The specific position is, for example, the center of the flow channel 20 in the depth direction, and the cell C1 passes through the vicinity of the center of the flow channel 20 in FIG. 2.

FIG. 2(A) is a diagram showing how the flow channel 20 is irradiated with the spotlight L2 when looking towards the −z side. As illustrated in FIG. 2(A), the illumination light L1 is applied as the spotlight L2 condensed in the width direction of the flow channel at the irradiation position of the flow channel. The irradiation position is a position at which the cell C1 passing through the flow channel 20 is irradiated with the spotlight L2. Condensing the illumination light L1 in the width direction of the flow channel 20 means, for example, that the illumination light L1 is condensed, from a side surface of the flow channel 20 to the center of the flow channel 20, in the width direction (the x-axis direction). In the width direction of the flow channel 20, the spotlight L2 is condensed within a constant range such that the width becomes narrower.

Here, the illumination light L1 is condensed such that a width of the spotlight L2 in the width direction of the flow channel 20 is substantially equal to the size (diameter) of the cell C1 which is a measurement object in the vicinity of the center of the flow channel 20 through which the cell C1 passes in the flow channel 20. The width of the spotlight L2 in the width direction of the flow channel 20 differs according to the size of a cell which is a measurement object or a phenomenon to be observed, preferably ranges from about 2 μm to about 100 μm, and more preferably ranges from about 5 μm to about 50 μm.

FIG. 2(B) is a diagram showing how the flow channel 20 is irradiated with the spotlight L2 when looking towards the −x side. As illustrated in FIG. 2(B), the illumination light L1 is applied as the spotlight L2 condensed in the depth direction of the flow channel at the irradiation position of the flow channel. At the irradiation position of the flow channel 20, the spotlight L2 is applied to be condensed on a specific position in the depth direction by the illumination optical system 4. Condensing the illumination light L1 in the depth direction (the z-axis direction) of the flow channel 20 means, for example, that the spotlight L2 is condensed in the depth direction of the flow channel 20 such that the width of the spotlight L2 in the depth direction of the flow channel 20 becomes narrower from the top surface of the flow channel 20 to a specific position in the depth direction of the flow channel 20. The width of the spotlight L2 in the depth direction of the flow channel 20 becomes wider as it moves away from the specific position to the bottom surface of the flow channel 20 in the depth direction.

In FIG. 2(B), the width of the spotlight L2 in the depth direction of the flow channel 20 is set to be most condensed in the vicinity of the center of the flow channel 20 through which the cell C1 passes in the flow channel 20 in the depth direction of the flow channel 20. The width of the spotlight L2 in the depth direction of the flow channel 20 differs according to the size of a cell which is a measurement object or a phenomenon to be observed, preferably ranges from 0.2 μm to 20 μm, and more preferably ranges from 0.1 μm to 10 μm. The width of the spotlight L2 in the depth direction of the flow channel 20 ranges from about sub μm to about 20 μm.

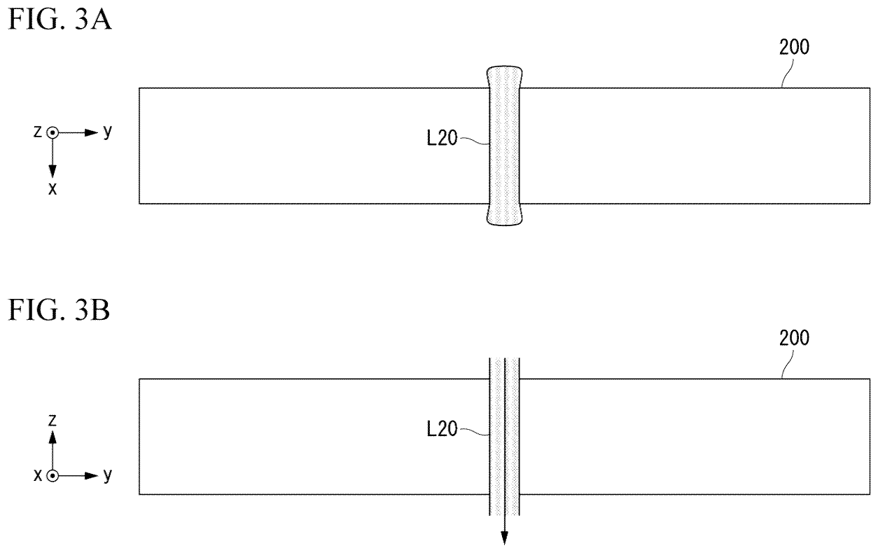

The shape of illumination light in a conventional and common flow cytometer will be described below with reference to FIG. 3 for the purpose of comparison with this embodiment. FIG. 3 is a diagram illustrating the shape of illumination light at an irradiation position of a conventional flow cytometer. Illumination light L20 in FIG. 3 is illumination light used in the conventional flow cytometer.

As illustrated in FIG. 3(A), the illumination light L20 is set to be wider than a flow channel 200 in the width direction of the flow channel 200 and to uniformly illuminate the flow channel. At that time, in the flow direction (the y-axis direction), the illumination light L20 is applied such that the width of the illumination light L20 becomes constant in a part crossing the flow channel 200. On the other hand, as illustrated in FIG. 3(B), the illumination light L20 is light which is substantially parallel in the depth direction of the flow channel 200, and the intensity of light to be applied is constant regardless of the depth of the flow channel 200. That is, at the irradiation position, the illumination light L20 has a spread shape capable of uniformly irradiating the whole flow channel in the width direction of the flow channel 200 and is applied as uniform light which is substantially parallel in the depth direction of the flow channel 200. In the conventional and ordinary flow cytometer, the illumination light L20 is not condensed at the irradiation position of the flow channel 200. Thus, when the intensity of the illumination light emitted from the light source is the same, the intensity of the illumination light L20 at the irradiation position becomes weaker in the conventional and ordinary flow cytometer than that in the flow cytometer 1 according to this embodiment.

In the flow cytometer 1, compared to the conventional and ordinary flow cytometers, the illumination light L1 is applied to the cell C1 flowing in the flow channel 20 as the spotlight L2, which is more condensed in both the width direction and the depth directions of the flow channel 20, at the irradiation position in the flow channel 20. Therefore, the intensity of the spotlight L2 applied to the cell C1 can further enhance the intensity of fluorescence emitted from a molecule specific to the cell C1 in comparison with a case in which the illumination is not condensed as described above.

The illumination optical system 4 may condense the illumination light L1 in only the width direction of the flow channel 20 at the irradiation position in the flow channel 20. The illumination optical system 4 may condense the illumination light L1 in only the depth direction of the flow channel 20 at the irradiation position in the flow channel 20. Accordingly, the illumination optical system 4 more condenses the illumination light L1 in at least one of the width direction and the depth direction of the flow channel 20 in comparison with the conventional and ordinary flow cytometer and the cell C1 flowing in the flow channel 20 is irradiated with the spotlight L2 having a higher intensity at the irradiation position in the flow channel 20.

Here, condensing the illumination light L1 in the width direction at the irradiation position in the flow channel 20 is also mentioned as setting a ratio of the width of the spotlight L2 in the width direction of the flow channel 20 to the width of the flow channel 20 to be equal to or less than a predetermined ratio. When the cell C1 passes through the center of the flow channel 20, the ratio of the width of the spotlight L2 in the width direction of the flow channel 20 to the width of the flow channel 20 is set to be equal to or less than the predetermined ratio at the center of the flow channel 20 in the width direction. The ratio of the width of the spotlight L2 in the width direction of the flow channel 20 to the width of the flow channel 20 differs according to the size of a measurement object and ranges, for example, from 1/20 to ½ although is not limited thereto.

Similarly, condensing the illumination light L1 in the depth direction at the irradiation position in the flow channel 20 is also mentioned as setting a ratio of the width of the spotlight L2 in the depth direction of the flow channel 20 to the depth of the flow channel 20 to be equal to or less than a predetermined ratio. When the cell C1 passes through a specific position in the depth direction of the flow channel 20, the ratio of the width of the spotlight L2 in the depth direction of the flow channel 20 to the depth of the flow channel 20 is set to be equal to or less than the predetermined ratio at the specific position in the depth direction of the flow channel 20. The ratio of the width of the spotlight L2 in the depth direction of the flow channel 20 to the depth of the flow channel 20 differs according to the size of a measurement object and ranges, for example, from 1/2000 to 1/10 although is not limited thereto.

One or both of the width of the spotlight L2 in the width direction of the flow channel 20 and the width of the spotlight L2 in the depth direction of the flow channel 20 may be smaller than the size of the cell C1. When a part of the cell C1 is irradiated with the spotlight L2 of a sufficient intensity, fluorescence is emitted from the part, and thus the width of the spotlight L2 in (one or both of) the width direction and the depth direction of the flow channel 20 may be smaller than the size of the cell C1.

As described above, the illumination optical system 4 may irradiate the cell C1 flowing in the flow channel 20 with the spotlight L2, which is obtained by condensing the illumination light L1 emitted from the light source 3, to the size of the cell C1 at the irradiation position in the flow channel 20.

Condensing the illumination light L1 in the width direction at the irradiation position in the flow channel 20 is also mentioned as setting the ratio (that is, contrast) of the intensity of the spotlight L2 at the center in the width direction of the flow channel 20 to the intensity of the spotlight L2 in the vicinity of a side surface of the flow channel 20 to be larger than a predetermined ratio.

Similarly, condensing the illumination light L1 in the depth direction at the irradiation position in the flow channel 20 is also mentioned as setting the ratio (that is, contrast) of the intensity of the spotlight L2 at a specific position in the depth direction of the flow channel 20 to the intensity of the spotlight L2 in the vicinity of the top surface and the bottom surface of the flow channel 20 to be larger than a predetermined ratio.

In addition, in the flow cytometer 1, the illumination light L1 is also condensed in the flow direction (the y-axis direction) of the flow channel 20 by the illumination optical system 4. It is preferable that the spotlight L2 be condensed to a diffraction limit of the objective lens 45 in the flow direction (the y-axis direction) of the flow channel 20 at the irradiation position in the flow channel 20.

Here, an SN ratio in the flow cytometer 1 according to this embodiment will be described below through comparison with the conventional flow cytometer.

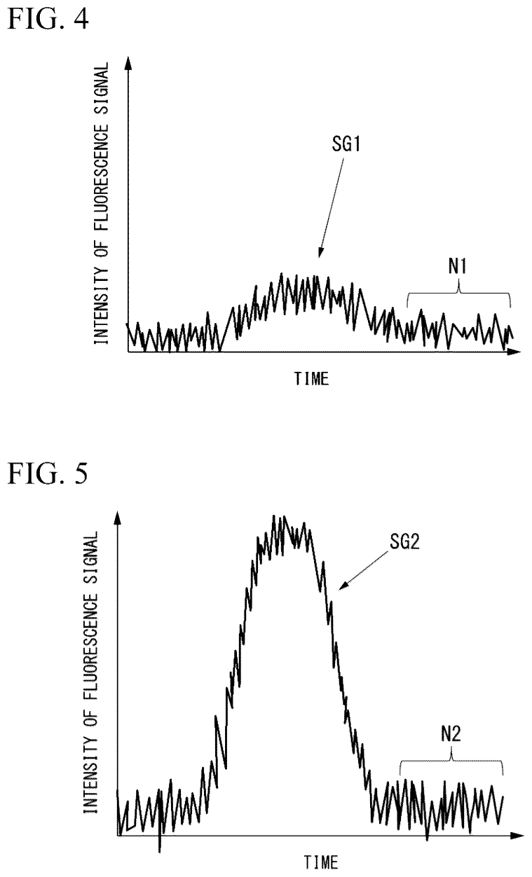

FIG. 4 is a diagram illustrating an example of a time-series waveform of fluorescence intensities detected by the conventional flow cytometer. FIG. 5 is a diagram illustrating an example of a time-series waveform of fluorescence intensities detected by the flow cytometer according to this embodiment. In both of the conventional flow cytometer and the flow cytometer according to this embodiment, a cell not labeled with a fluorescent dye is used as a measurement object, and the intensity of autofluorescence uniquely emitted from the cell is detected as a time-series waveform using the flow cytometers. In FIGS. 4 and 5, data of time-series waveforms observed by an oscilloscope is schematically illustrated.

The time-series waveform of the intensity of fluorescence illustrated in FIG. 4 indicates a time-series waveform of the intensity of fluorescence detected when illumination light like the illumination light L20 illustrated in FIG. 3 is shaped and applied to a cell which is a measurement object at the irradiation position in the flow channel. As described above, at the irradiation position, the illumination light L20 has a spread shape capable of uniformly irradiating the whole flow channel in the width direction of the flow channel 200 and is applied as substantially parallel and uniform light in the depth direction of the flow channel 200. In the conventional flow cytometer, uniformity of a distribution of illumination light at the irradiation position is considered as being important. In other words, considering uniformity of the distribution of illumination light as being important corresponds to making the distribution of illumination light uniform and suppressing variation of a signal intensity according to a passing position of the measurement object.

In the conventional flow cytometer, since uniformity of the distribution of illumination light is considered as being important, power of excitation light per unit volume of a measurement object is weakened. As a result, a fluorescence signal with a high intensity cannot be obtained, and only a fluorescence signal with a low SN ratio (a signal SG1 in FIG. 4) is obtained. Here, the SN ratio can be quantified, for example, as a ratio in standard deviation of the intensity of background noise to the fluorescence intensity due to autofluorescence of the measurement object. In the example illustrated in FIG. 4, the SN ratio is a ratio of standard deviation of the intensity of noise N1 to the peak height of the signal SG1.

On the other hand, the time-series waveform of the intensity of fluorescence illustrated in FIG. 5 indicates a time-series waveform of the intensity of fluorescence detected when illumination light like the illumination light L2 illustrated in FIG. 2 is shaped and applied to a cell which is a measurement object at the irradiation position in the flow channel. As described above, the spotlight L2 is applied as illumination light having a shape condensed in both the width direction and the depth direction of the flow channel 20 at the irradiation position. In the flow cytometer 1 according to this embodiment, the illumination light can be applied as a spotlight condensed on a cell which is a measurement object at the irradiation position. Accordingly, in the flow cytometer 1 according to this embodiment, a fluorescence signal with a strong intensity (a signal SG2 in FIG. 5) can be obtained, and thus a fluorescence signal with a high SN ratio can be obtained. In the example illustrated in FIG. 5, the SN ratio is a ratio of standard deviation of the intensity of noise N2 to the peak height of the signal SG2.

Description of the configuration of the flow cytometer 1 will be continued with reference back to FIG. 1.

When the irradiation position in the flow channel 20 is irradiated with the spotlight L2 by the illumination optical system 4, the cell C1 flowing in the flow channel 20 emits fluorescence. Here, the fluorescence is emitted from a specific molecule of the cell C1 in response to the irradiation with the spotlight L2 by the illumination optical system 4. That is, the fluorescence is natural emission of light which is emitted when a biological structure of the cell C1 absorbs the spotlight L2 and is called autofluorescence. Here, fluorescence incident on the objective lens 45 out of the fluorescence emitted as autofluorescence of the cell C1 is referred to as fluorescence F1.

The fluorescence F1 emitted from the cell C1 is incident on the objective lens 45. The fluorescence F1 incident on the objective lens 45 is incident as parallel light on the dichroic mirror 44. The dichroic mirror 44 transmits the fluorescence F1 emitted as parallel light from the objective lens 45 to the detection optical system 5.

The detection optical system 5 causes the fluorescence F1 emitted from the cell C1 to propagate to the light detector 6 which will be described later. In the flow cytometer 1 illustrated in FIG. 1, the detection optical system 5 separates the fluorescence F1 emitted from the cell C1 into spectrum components and causes the spectrum components to propagate the light detector 6. The detection optical system 5 includes the objective lens 45, the dichroic mirror 44, a lens 51, a slit 52, a lens 53, a diffraction grating 54, and a lens 55. The objective lens 45, the dichroic mirror 44, the lens 51, the slit 52, the lens 53, the diffraction grating 54, and the lens 55 are arranged on an optical path between the flow channel 20 and the light detector 6 sequentially from the side closest to the flow channel 20. The objective lens 45 and the dichroic mirror 44 are included in both the illumination optical system 4 and the detection optical system 5.

The spotlight L2 is applied to the cell C1 flowing in the flow channel 20, and fluorescence F1 which is autofluorescence is emitted from the cell C1. The fluorescence F1 emitted from the cell C1 is incident on the objective lens 45. The fluorescence F1 incident on the objective lens 45 is incident on the dichroic mirror 44, and the fluorescence F1 transmitted by the dichroic mirror 44 propagates to the lens 51.

The lens 51 is a biconvex lens. The lens 51 condenses the fluorescence F1 which is parallel light transmitted by the dichroic mirror 44 on the position of the slit 52.

The slit 52 is an iris. The slit 52 is disposed at a focal position of the lens 51. The focal position also matches a focal position of the lens 53. The slit 52 causes the fluorescence F1 condensed by the lens 51 to diverge and to be incident on the lens 53.

The lens 53 is a biconvex lens. The lens 53 causes the fluorescence F1 diverging and emitted from the slit 52 to be incident as parallel light on the diffraction grating 54.

The diffraction grating 54 separates the fluorescence F1 emitted as parallel light from the lens 53 into spectrum components SP1 according to wavelengths of the fluorescence F1. The diffraction grating 54 separates the incident fluorescence F1 by wavelengths through diffraction. The diffraction grating 54 causes the separated spectrum component SP1 to be incident on the lens 55.

The detection optical system 5 may have a different configuration as long as it can separate the fluorescence F1 into spectrum components with different wavelengths through dispersion, refraction, or reflection. For example, the detection optical system 5 may include a prism or an optical filter instead of the diffraction grating 54.

The lens 55 condenses the spectrum components SP1 separated by the diffraction grating 54 on the light detector 6. When the number of spectrum components SP1 is two or more, the lens 55 individually condenses the plurality of spectrum components SP1 and causes the spectrum components to be incident on the light detector 6.

The light detector 6 detects the fluorescence F1 separated into the spectrum components SP1 by the detection optical system 5 for each spectrum component SP1. The light detector 6 detects the spectrum components SP1 as optical signals and converts the optical signals to electrical signals. The light detector 6 is, for example, a photomultiplier tube (PMT). The light detector 6 detects the optical signals in a time series. The light detector 6 is, for example, a multi sensor.

The light detector 6 is, for example, a multi-anode PMT in which a plurality of channels are provided. The plurality of channels have different sensitivities to wavelengths. The plurality of channels detect the plurality of spectrum components SP1 of different wavelengths. Accordingly, the light detector 6 includes a plurality of light detectors (channels) for detecting the fluorescence F1 separated into the spectrum components SP1 by the detection optical system 5 for each spectrum component SP1.

The number of channels provided in the light detector 6 may be one. That is, the light detector 6 may be a single sensor (a single PMT). When the light detector 6 is a single sensor, the light detector 6 detects a spectrum component SP1 corresponding to one type of wavelength.

In FIG. 1, three types of spectrum components SP1 are illustrated, but the number of spectrum components SP1 varies according to the fluorescence F1. The number of types of spectrum components SP1 may be other than three.

A DAQ device 7 converts electrical signal pulses output from the light detector 6 to electronic data for each pulse. The electronic data includes a group of a time and an intensity of an electrical signal pulse. The DAQ device 7 is, for example, an oscilloscope.

The information processing device 8 performs various types of analysis based on the electronic data output from the DAQ device 7. The information processing device 8 is, for example, a personal computer (PC).

### Configuration of Information Processing Device 8

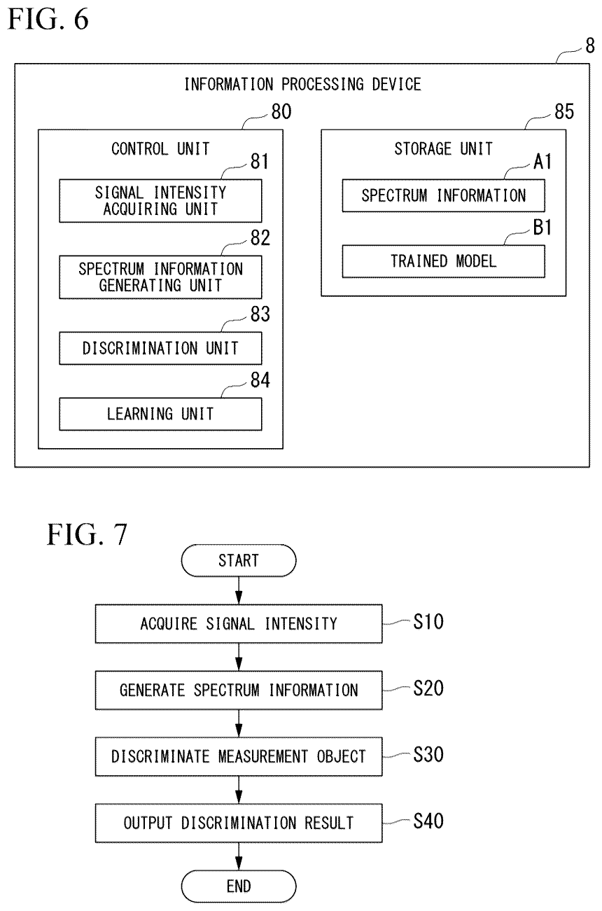

The configuration of the information processing device 8 will be described below with reference to FIG. 6. FIG. 6 is a diagram illustrating an example of the configuration of the information processing device 8 according to this embodiment. The information processing device 8 includes a control unit 80 and a storage unit 85.

The control unit 80 includes, for example, a central processing unit (CPU), a graphics-processing unit (GPU), and a field-programmable gate array (FPGA) and performs various arithmetic operations and transmission and reception of information.

The control unit 80 includes a signal intensity-acquiring unit 81, a spectrum information-generating unit 82, a discrimination unit 83, and learning unit 84.

The signal intensity-acquiring unit 81 acquires electronic data output from the DAQ device 7. The electronic data is electronic data indicating signal intensities of the spectrum components SP1 detected by the light detector 6 ever time.

The spectrum information-generating unit 82 generates spectrum information A1 based on electronic data acquired by the signal intensity-acquiring unit 81. The spectrum information A1 is information of the spectrum components SP1 for the cell C1 which is a measurement object.

The spectrum information A1 includes one or more of the following values.
(A) Fluorescence intensity at each excited fluorescence wavelength detected by the light detector 6.
(B) A normalized value (an intensity ratio) of the above fluorescence intensity using a fluorescence intensity at a specific wavelength.
(C) A normalized value using the light intensity (total amount, height) of the illumination light L1 or the spotlight L2.
(D) A value obtained through one or more of the processes (A), (B), and (C) for fluorescence wavelength excited by each excitation light of different wavelengths.

In (A) above, the fluorescence intensity is an intensity of the spectrum component SP1 and is represented by a total amount or a height. The total amount indicating the fluorescence intensity is an area obtained by integrating a signal intensity of the spectrum component SP1 with respect to time in the electronic data output from the DAQ device 7. The height indicating the fluorescence intensity is a height of a peak (a maximum value) of a signal intensity of the spectrum component SP1 in the relevant electronic data.

Above (B) includes a case where, when the cell C1 is irradiated with excitation light (the spotlight L2) of different wavelengths, the intensity values of emitted fluorescence are normalized using fluorescence of a specific wavelength within fluorescence emitted by each excitation light. Also, a case is included in (B) where, when the cell C1 is irradiated with excitation light (the spotlight L2) of different wavelengths, the intensity values of fluorescence emitted by the corresponding excitation light are normalized using fluorescence of a specific wavelength within fluorescence emitted by each excitation light.

For the purpose of explanation of (B), it is assumed that excitation light has only one wavelength. In this case, when fluorescence intensities detected at N fluorescence wavelengths are defined as a1, a2, . . . , and aN, respectively, fluorescence intensities (ax, where x=1, . . . , N) at different fluorescence wavelengths can be normalized using a fluorescence intensity ai at a certain fluorescence wavelength. The normalized value is represented by ax/ai. As x=1, . . . , N, there are N values for the fluorescence intensity ax, and thus N values for the normalized values are acquired.

Then, when a plurality of (let that be M items) excitation light components are present and a plurality of (let that be N items) fluorescence wavelengths are detected, N×M fluorescence intensities are detected. In the above (B), at least two methods are included in a method of normalizing the N×M fluorescence intensities.

In the first method, fluorescence intensities detected at N fluorescence wavelengths for excitation light of wavelengths λi (where i=1, . . . , M) are defined as a1(λi), a2(λi), . . . , and aN(λi), respectively. At this time, fluorescence intensities detected at all fluorescence wavelengths in response to the excitation light of all the wavelengths are normalized with the fluorescence intensity aj(λi) detected at a certain wavelength in response to excitation light of a certain wavelength λi. The normalized values are represented by ax (λy)/aj(λi) (where x=1, . . . , N, and y=1, . . . , M). In the first method, N×M normalized values, which are equal to the results obtained by multiplying the number of excitation wavelengths by the number of fluorescence wavelengths, are obtained.

In the second method, for each excitation light of wavelength λi (i=1, . . . , M), fluorescence intensities ax (λi) detected at different fluorescence wavelengths are normalized using the fluorescence intensity aj(λi) detected at one selected fluorescence wavelength. The normalized values are represented by ax (λi)/aj(λi) (where x=1, . . . , N). In the second method, the values used for normalization are different among M excitation wavelengths.

The spectrum information A1 corresponds to a total amount of fluorescence F1 emitted from a molecule specific to the cell C1 in response to irradiation with the spotlight L2. Information of the spectrum components SP1 indicated by the spectrum information A1 corresponds to fluorescence characteristics specific to the cell C1, and the spectrum information A1 can be used to discriminate the cell C1.

The discrimination unit 83 discriminates the cell C1 which is a measurement object based on the trained model B1 and the spectrum information A1. The trained model B1 is, for example, a model for discriminating whether the measurement object is a target measurement object when spectrum information A1 of the measurement object is input.

The learning unit 84 generates the trained model B1. The learning unit 84 generates the trained model B1 by performing machine learning on a learning sample using training data in which the spectrum information A1 and identification information are combined. The learning sample is a sample for acquiring spectrum information A1 used for machine learning and includes target measurement objects and measurement objects other than the target measurement objects. The identification information is information for identifying the target measurement objects. The identification information is, for example, a label indicating the type of cell.

An algorithm of machine learning performed by the learning unit 84 is a support vector machine (SVM), a decision tree analysis, a neural network, or the like. The algorithm of machine learning may be an supervised learning algorithm other than described above. An supervised learning algorithm may be used in combination with a unsupervised learning algorithm as the machine learning performed by the learning unit 84.

The learning unit 84 stores the generated trained model B1 in the storage unit 85.

As described above, the learning unit 84 generates the trained model B1 by performing machine learning on the learning sample including target measurement objects and measurement objects other than the target measurement objects using training data in which information of spectrum components (spectrum information A1) detected by the light detector 6 and information (identification information) for identifying the target measurement objects are combined. The method of generating a trained model B1 is not limited thereto and a trained model can be generated by performing learning using another known method.

The trained model B1 may be generated in advance by an external information processing device outside of the flow cytometer 1. In this case, the control unit 80 does not include the learning unit 84, and the information processing device 8 acquires the trained model B1 generated by the external information processing device and stores the trained model B1 in the storage unit 85. Regarding the trained model B1, training data in which the spectrum information A1 and the identification information are combined may be transmitted to the external information processing device, and the external information processing device may be caused to generate the trained model B1. In this case, the control unit 80 does not include the learning unit 84, and the information processing device 8 acquires the generated trained model B1 from the external information processing device, stores the acquired trained model in the storage unit 85, and uses the trained model.

The storage unit 85 stores various types of information. Information stored in the storage unit 85 includes the spectrum information A1 and the trained model B1. The storage unit 85 is constituted by a storage device such as a magnetic hard disk device or a semiconductor storage device.

The functional units of the control unit 80 are realized, for example, by causing a CPU to read and execute a program from a read-only memory (ROM). The discrimination unit 83 may discriminate a measurement object based on the trained model B1 set in a programmable logic device (PLD) such as a field-programmable gate array (FPGA).

### Discrimination Process

A discrimination process, which is a process of discriminating a target measurement object performed by the information processing device 8, will be described below with reference to FIG. 7. FIG. 7 is a diagram illustrating an example of the discrimination process according to this embodiment. The discrimination process is performed immediately while a plurality of the cells C1 are flowing in the flow channel 20 in the flow cytometer 1. The trained model B1 is generated by the learning unit 84 and stored in the storage unit 85 in advance. A measurement sample on which the discrimination process is performed includes a plurality of the cells C1 including target measurement objects and measurement objects other than the target measurement objects. The flow cytometer 1 discriminates target measurement objects from measurement objects other than the target measurement objects from the cells C1 flowing in the flow channel 20 using the trained model B1.

Step S10: The signal intensity-acquiring unit 81 acquires electronic data output from the DAQ device 7.

Step S20: The spectrum information-generating unit 82 generates spectrum information A1 based on the electronic data acquired by the signal intensity-acquiring unit 81.

Step S30: The discrimination unit 83 discriminates a measurement object based on the trained model B1 and the spectrum information A1. Here, the discrimination unit 83 discriminates whether the cell C1, which is the measurement object, is a target measurement object based on the trained model B1 and the spectrum information A1. The discrimination unit 83 may discriminate whether the cell C1, which is the measurement object, is a target measurement object or a measurement object other than the target measurement object based on the trained model B1 and the spectrum information A1.

Step S40: The discrimination unit 83 outputs a discrimination result to an output device. The output device is, for example, a display. The discrimination unit 83 may store the discrimination result in the storage unit 85.

After these steps, the information processing device 8 ends the discrimination process.

In the example illustrated in FIGS. 6 and 7, the information processing device 8 in the flow cytometer 1 according to this embodiment includes the learning unit 84 and performs the discrimination process based on a trained model generated by the learning unit 84, but the present invention is not limited thereto. The flow cytometer 1 according to this embodiment may not use a trained model for the discrimination process and thus the information processing device 8 may not include the learning unit 84. In this case, the flow cytometer 1 according to this embodiment discriminates whether a measurement object is a target measurement object based on fluorescence information regarding fluorescence emitted from the measurement object in response to irradiation with a spotlight.

### Modified Example 1

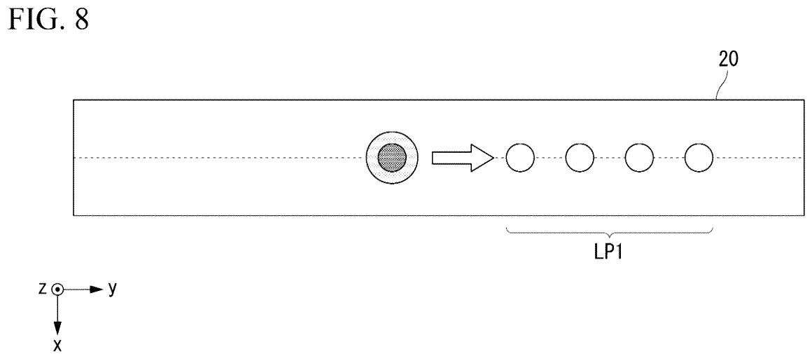

The illumination optical system 4 may apply the spotlight L2 such that a plurality of light spots are formed at the irradiation position in the flow channel 20. For example, as illustrated in FIG. 8, the illumination optical system 4 applies the spotlight L2 such that a plurality of light spots are arranged in a line shape in the flow direction (the +y side) of the flow channel at the irradiation position in the flow channel 20. In a straight pattern LP1 illustrated in FIG. 8, a plurality of light spots are arranged in a line shape at appropriate intervals (for example, equal intervals) in the flow direction of the flow channel at the same position (for example, the vicinity of the center of the flow channel 20 through which the cell C1 passes) in the width direction (the x-axis direction in FIG. 8) of the flow channel 20. Accordingly, a cell passing through the same position in the width direction (the x-axis direction in FIG. 8) of the flow channel 20 can be continuously irradiated using the plurality of light spots arranged in a line shape.

In order to form a plurality of light spots at the irradiation position in the flow channel 20, the light source 3 may include a plurality of light sources. When the light source 3 includes a plurality of light sources, peak wavelengths of illumination light emitted from the plurality of light sources may be the same or different from each other. For example, when the plurality of light spots are formed by a light source emitting excitation light of different wavelengths, it is possible to simultaneously acquire autofluorescence spectra of a cell in response to the excitation light of different wavelengths and it makes possible to take out spectrum information A1 as plentiful information.

In order to form a plurality of light spots at the irradiation position in the flow channel 20, illumination light emitted from one light source can be split into a plurality of illumination light components for use. When illumination light is split into a plurality of illumination light components, an optical path of the illumination light may be split into a plurality of optical paths by optical elements such as a mirror and a lens. In addition, the illumination light may be split by a spatial light modulator.

The number of light spots arranged at the irradiation position may be an arbitrary number. When illumination light emitted from one light source is split, it is preferable that the number of light spots for each light source be set to be less than five in view of securing the intensity of the illumination light L1.

### Second Embodiment

A second embodiment of the present invention will be described below in detail with reference to the drawings.

In the first embodiment, the flow cytometer 1 detects spectrum components SP1 of fluorescence F1 emitted from a cell C1. In this embodiment, the flow cytometer detects scattered light other than fluorescence F1 in addition to the fluorescence F1. The flow cytometer according to this embodiment is referred to as a flow cytometer 1a.

The same elements as in the first embodiment will be referred to by the same reference signs, and description of the same elements and operations may be omitted.

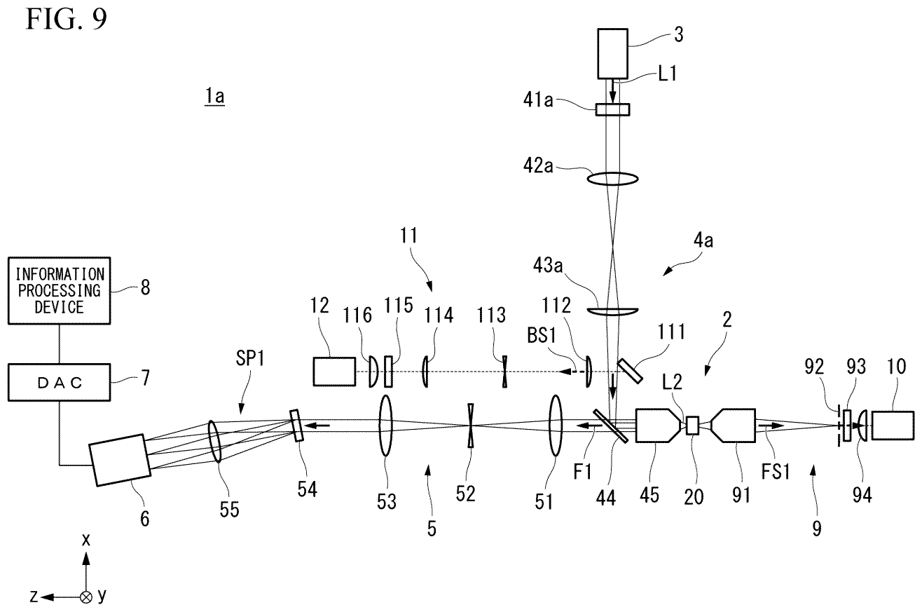

FIG. 9 is a diagram illustrating an example of the configuration of the flow cytometer 1a according to this embodiment. The flow cytometer 1a includes a microfluidic device 2, a light source 3, an illumination optical system 4a, a detection optical system 5, a light detector 6, a DAC 7, an information processing device 8, an FSC detection optical system 9, a PMT 10, a BSC detection optical system 11, and a PMT 12.

The flow cytometer 1a (FIG. 9) according to this embodiment is different from the flow cytometer 1 (FIG. 1) according to the first embodiment in that the flow cytometer 1a includes the FSC detection optical system 9, the PMT 10, the BSC detection optical system 11, and the PMT 12. The FSC detection optical system 9 and the PMT 10 are elements for detecting forward scattered light (FSC). The BSC detection optical system 11 and the PMT 12 are elements for detecting backward scattered light (BSC). The flow cytometer 1a is different from the flow cytometer 1 in that the illumination optical system 4a is provided as an illumination optical system in order to perform FSC detection and BSC detection at the same time as autofluorescence detection.

The illumination optical system 4a includes a third lens 41a, a fourth lens 42a, a fifth lens 43a, a dichroic mirror 44, and an objective lens 45. The third lens 41a, the fourth lens 42a, the fifth lens 43a, the dichroic mirror 44, and the objective lens 45 are arranged on an optical path between the light source 3 and the flow channel 20 sequentially from a side closest to the light source 3.

The third lens 41a is a cylindrical lens. The third lens 41a condenses illumination light L1 emitted from the light source 3 in only one direction. The third lens 41a causes the illumination light L1 to be incident on the fourth lens 42a such that the illumination light L1 is parallel light when seen in the y-axis direction in the example of the configuration illustrated in FIG. 9. On the other hand, the third lens 41a causes the illumination light L1 to be incident on the fourth lens 42a such that the illumination light L1 diverges when seen in the z-axis direction in the example of the configuration illustrated in FIG. 9. The fourth lens 42a is a biconvex lens. When seen in the y-axis direction in the example of the configuration illustrated in FIG. 9, the illumination light L1 which is emitted from the third lens 41a as parallel light is condensed in the z-axis direction by the fourth lens 42a. As a result, the illumination light L1 is condensed in the Z-axis direction once at the focal position of the fourth lens 42a and then diffused to be incident on the fifth lens 43a. On the other hand, when seen in the z-axis direction in the example of the configuration illustrated in FIG. 9, the fourth lens 42a included in the illumination optical system 4a causes the illumination light L1 emitted from the third lens 41a to be incident on the fifth lens 43a such that the illumination light L1 is parallel light.

The fifth lens 43a is a cylindrical lens. When seen in the y-axis direction, the fifth lens 43a is disposed such that its plane side faces the light source 3 and its convex surface side faces the flow channel 20. The fifth lens 43a condenses the illumination light L1, which is diffused and emitted from the fourth lens 42a, in the z-axis direction and causes it to be incident on the dichroic mirror 44. On the other hand, when the illumination optical system 4a is seen in the z-axis direction, the fifth lens 43a causes the illumination light L1 which is transmitted and emitted by the fourth lens 42a to be incident on the dichroic mirror 44. In this case, the width of the illumination light L1 remains the same as when it is emitted from the fourth lens 42a.

The dichroic mirror 44 reflects the illumination light L1, which is emitted from the fifth lens 43a as parallel light. The dichroic mirror 44 causes the reflected illumination light L1 to be incident on the objective lens 45.

The FSC detection optical system 9 includes an objective lens 91, a spatial filter 92, a band-pass filter 93, a lens 94, the objective lens 45, and the dichroic mirror 44. The objective lens 91, the spatial filter 92, the band-pass filter 93, and the lens 94 are arranged on an optical path between the flow channel 20 and the PMT 10 sequentially from the side closest to the flow channel 20.

The objective lens 91 condenses forward scattered light FS1 and causes the forward scattered light FS1 to be incident on the spatial filter 92. The forward scattered light FS1 is the scattered light scattered in the irradiation direction (the −z side in FIG. 9) of the spotlight L2 by the cell C1 flowing in the flow channel 20 when a spotlight L2 is applied to the cell C1.

The spatial filter 92 cuts off direct light out of incident light and transmits the forward scattered light FS1 propagating forward.

The band-pass filter 93 transmits light of a wavelength included in a predetermined wavelength range in which FSC detection is performed and does not transmit light of a wavelength not included in the wavelength range.

The lens 94 is a plano-convex lens. The lens 94 is disposed such that its plane side faces the PMT 10 and its convex surface side faces the flow channel 20. The lens 94 condenses the forward scattered light FS1 transmitted by the spatial filter 92 and the band-pass filter 93 to the PMT 10.

The PMT 10 detects the forward scattered light FS1.

The BSC detection optical system 11 includes a mirror 111, a lens 112, a slit 113, a lens 114, a band-pass filter 115, a lens 116, an objective lens 45, and a dichroic mirror 44. The mirror 111, the lens 112, the slit 113, the lens 114, the band-pass filter 115, and the lens 116 are arranged on an optical path between the flow channel 20 and the PMT 12 sequentially from the side closest to the flow channel 20.

Backward scattered light BS1 is the scattered light scattered in a direction (the +z side in FIG. 9) opposite to the irradiation direction of the spotlight L2 by the cell C1 flowing in the flow channel 20 when a spotlight L2 is applied to the cell C1. The backward scattered light BS1 is incident on the objective lens 45. The backward scattered light BS1 incident on the objective lens 45 is incident as parallel light on the dichroic mirror 44. The dichroic mirror 44 reflects the backward scattered light BS1 emitted as parallel light from the objective lens 45 to the mirror 111.

The mirror 111 reflects the backward scattered light BS1 to the lens 112.

The lens 112 is a plano-convex lens. The lens 112 is disposed such that its convex surface side faces the mirror 111 and its plane side faces the PMT 12. The lens 112 condenses the backward scattered light BS1 reflected by the mirror 111 to the slit 113. The slit 113 is an iris. The slit 113 is disposed at the focal position of the lens 112. The focal position matches the focal position of the lens 114. The slit 113 causes the backward scattered light BS1 condensed by the lens 112 to diverge and to be incident on the lens 114.

The lens 114 is a plano-convex lens. The lens 114 is disposed such that its plane side faces the mirror 111 and its convex surface side faces the PMT 12. The lens 114 causes the backward scattered light BS1 diverging and emitted from the slit 113 to be incident as parallel light on the band-pass filter 115.

The band-pass filter 115 transmits light of a wavelength included in a predetermined wavelength range in which BSC detection is performed and does not transmit light of a wavelength not included in the wavelength range.

The lens 116 is a plano-convex lens. The lens 116 is disposed such that its convex surface side faces the mirror 111 and its plane side faces the PMT 12. The lens 116 condenses the backward scattered light BS1 transmitted by the band-pass filter 115 to the PMT 12.

The PMT 12 detects the backward scattered light BS1.

Since the flow cytometer 1a according to this embodiment includes a configuration for detecting forward scattered light FS1 (the FSC detection optical system 9 and the PMT 10) and the configuration for detecting backward scattered light BS1 (the BSC detection optical system 11 and the PMT 12), it is possible to detect the forward scattered light FS1 and the backward scattered light BS1 along with fluorescence F1 and thus to simultaneously acquire a plurality of types of optical information on a measurement object. Accordingly, with the flow cytometer 1a, it is possible to increase an amount of information for a measurement object that is available through one measurement in comparison with the flow cytometer 1 according to the first embodiment. That is, with the flow cytometer 1a, it is possible to discriminate a measurement object appropriately using information of forward scattered light FS1 and backward scattered light BS1 in addition to information of autofluorescence (fluorescence F1) of the measurement object.

### Third Embodiment

With the flow cytometers according to the aforementioned embodiments, it is possible to detect fluorescence F1 emitted from a cell C1 using ghost cytometry technology. In the ghost cytometry technology, light applied to a measurement object is detected as a GMI signal including morphological information of the cell C1 using a dynamic ghost motion imaging (GMI) method. In the ghost cytometry technology, discrimination of the cell C1 is performed using a classifier which is generated by directly performing machine learning of GMI signals including morphological information of the cells C1. Therefore, it is possible to determine or discriminate a measurement object based on the morphological information with a higher resolution in the ghost cytometry technology. In this embodiment, an embodiment in which the ghost cytometry technology is combined with the flow cytometers according to the aforementioned embodiments will be described. The flow cytometer according to this embodiment can acquire morphological information of the cell C1 as information with a higher resolution based on autofluorescence derived from the cell C1 in comparison with the flow cytometers according to the aforementioned embodiments.

As a method of detecting fluorescence as a GMI signal using the GMI method, a method of adding a configuration of structured illumination, in which illumination light is structured, to the illumination optical system of the flow cytometers according to the aforementioned embodiments and a method of adding a configuration of structured detection, in which autofluorescence is structured and detected, to the detection optical system of the flow cytometers according to the aforementioned embodiments are known. An example in which the configuration of structured illumination is added will be mainly described below.

A third embodiment of the present invention will be described below in detail with reference to the drawings. The flow cytometer according to this embodiment is referred to as a flow cytometer 1b. The same elements as in the first embodiment will be referred to by the same reference signs, and description of the same elements and operations may be omitted.

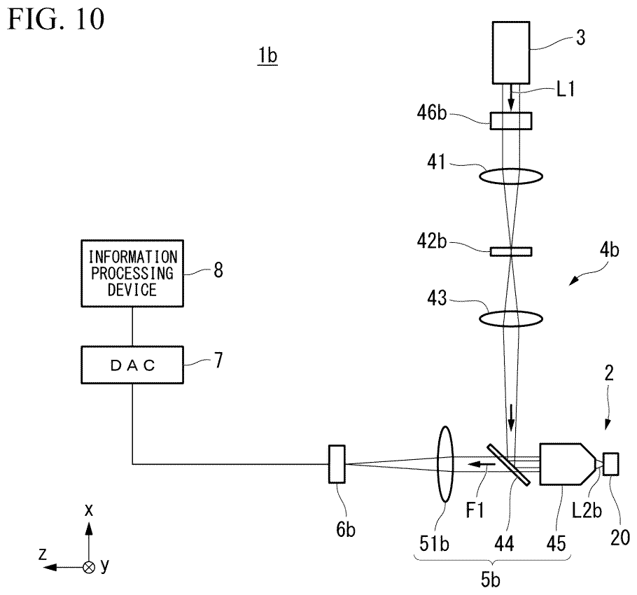

FIG. 10 is a diagram illustrating an example of the configuration of the flow cytometer 1b according to this embodiment. The flow cytometer 1b includes a microfluidic device 2, a light source 3, an illumination optical system 4b, a detection optical system 5b, a light detector 6b, a DAC 7, and an information processing device 8. The flow cytometer 1b (FIG. 10) according to this embodiment is different from the flow cytometer 1 (FIG. 1) according to the first embodiment and the flow cytometer 1a (FIG. 9) according to the second embodiment in that the flow cytometer 1b includes the illumination optical system 4b, the detection optical system 5b, and the light detector 6b.

In the example illustrated in FIG. 10, the illumination optical system 4b includes a spatial light modulator 46b, a first lens 41, a spatial filter 42b, a second lens 43, a dichroic mirror 44, and an objective lens 45. The spatial light modulator 46b structures illumination light L1 emitted from the light source 3. The illumination optical system 4b structures the illumination light L1 and applies it to the cell C1 at the irradiation position in the flow channel 20 as a condensed and structured spotlight L2b. In FIG. 10, the spatial light modulator 46b, the first lens 41, the spatial filter 42b, the second lens 43, the dichroic mirror 44, and the objective lens 45 are arranged on an optical path between the light source 3 and the flow channel 20 sequentially from the side closest to the light source 3, but the spatial light modulator 46b may be disposed at a different position of the illumination optical system 4b as long as it is disposed on the optical path between the light source 3 and the flow channel 20.

The first lens 41 condenses the structured illumination light L1 emitted from the spatial light modulator 46b to the spatial filter 42b. The spatial filter 42b removes components corresponding to spatially varying noise from the illumination light L1 condensed by the first lens 41 and makes an intensity distribution of the illumination light L1 closer to a Gaussian distribution. The second lens 43 makes the illumination light L1 from which noise has been removed by the spatial filter 42b into parallel light.

Structuring the illumination light L1 means to modulate optical characteristics of the illumination light L1 for each of a plurality of areas included in an incidence surface of the illumination light L1. The spatial light modulator 46b is an optical element that changes a spatial distribution of incident light with a designed microstructure and modulates optical characteristics of the incident light. The surface of the spatial light modulator 46b on which light is incident includes a plurality of areas, and the optical characteristics of the illumination light L1 are individually modulated by the plurality of areas through which the light passes. That is, the optical characteristics of the illumination light L1 are changed such that the optical characteristics in the plurality of areas differ from each other by causing the illumination light to pass through the spatial light modulator 46b. The spatial light modulator 46b enables to give a pattern to the illumination light L1 and apply it as structured illumination light by changing the optical characteristics in the plurality of areas.

Here, the optical characteristics are, for example, characteristics of light including one or more of an intensity, a wavelength, a phase, and a polarized state, but the optical characteristics are not limited thereto. For example, the spatial light modulator 46b spatially splits the illumination light L1 using a light diffraction phenomenon and modulates the optical characteristics of the illumination light L1 so as to be applied to an irradiation position in the flow channel as structured illumination light having a plurality of light spots.

The spatial light modulator 46b is, for example, a diffractive optical element (DOE). The spatial light modulator 46b is a spatial light modulator (SLM), a digital mirror device (DMD), or the like. When the illumination light L1 emitted from the light source 3 is incoherent light, the spatial light modulator 46b is a DMD.

The illumination optical system 4b irradiates the irradiation position in the flow channel 20 with a structured spotlight L2b. The structured spotlight L2b is applied, for example, in such a way to form a pattern having a plurality of light spots at the irradiation position in the flow channel 20. In the pattern formed by the structured spotlight L2b, for example, a plurality of light spots are irregularly arranged at the irradiation position in the flow channel 20. The size of one light spot depends on the size of a measurement object and preferably ranges from several μm to about 10 μm when the measurement object is a cell.

The illumination optical system 4b condenses and applies the structured spotlight L2b in the same range as the spotlight L2 in the first embodiment. For example, the structured spotlight L2b is condensed to a predetermined range such that the width decreases in the width direction of the flow channel 20. The structured spotlight L2b may be condensed and applied to a predetermined range from a specific position in the depth direction of the flow channel 20. A position and a range to which the structured spotlight L2b is condensed and applied in the flow channel 20 is the same as the position and the range described for the spotlight L2 in the first embodiment.

In this configuration, there is a possibility that an amount of light applied to the cell C1 may be weakened by the spatial light modulator 46b included in the illumination optical system 4b. Accordingly, in order to acquire autofluorescence (fluorescence F1) emitted by the cell C1 with high sensitivity, it is effective to include a mechanism for condensing the structured spotlight L2b to irradiate the cell C1 at the irradiation position in the flow channel 20.

In FIG. 10, the configuration of a structuring illumination is illustrated as a configuration in which the illumination optical system 4b includes the spatial light modulator 46b, but the present invention is not limited thereto. The configuration for applying a spotlight L2 such that a plurality of light spots are formed at the irradiation position in the flow channel 20 as in Modified Example 1 may be used as the configuration of a structuring illumination. The configuration for applying a spotlight L2 such that a plurality of light spots are formed at the irradiation position in the flow channel 20 can be constructed, for example, by irradiating the irradiation position in the flow channel 20 with illumination light from a plurality of light sources.

In the flow cytometer 1b, the detection optical system 5b includes the objective lens 45, the dichroic mirror 44, and an imaging optical system 51b. The imaging optical system 51b is an optical structure for condensing a GMI signal of fluorescence F1 from the cell C1 to the light detector 6 and includes an imaging lens. The imaging lens does not need to form an image at the position of the light detector 6 as long as the GMI signal from the cell C1 is condensed to the position. However, it is preferable that the imaging lens is disposed at the position where the signal light LS is imaged at the position of the light detector 6. The detection optical system 5b may additionally include a dichroic mirror or a wavelength-selective filter.

The fluorescence F1 passing through the objective lens 45 and the dichroic mirror 44 is condensed as a GMI signal to the light detector 6b via the imaging optical system 51b. The light detector 6b detects the GMI signal as an optical signal and converts it to an electrical signal. The light detector 6 is, for example, a photomultiplier tube (PMT).

The fluorescence F1 emitted in response to the structured spotlight L2 may be detected using the same detection optical system 5 as in the first embodiment. In this case, spectrum components separated by the diffraction grating 54 are individually detected as a GMI signal for each individual component by a plurality of light detectors 6.

On the other hand, in the flow cytometer 1b according to this embodiment, fluorescence may be detected as a GMI signal by the configuration of structured detection. In this case, in the configuration of the flow cytometer 1b, the spatial light modulator 46b can be excluded from the illumination optical system 4b. In the flow cytometer 1b, a mask and a mask imaging lens are added to the detection optical system 5b on an optical path of the fluorescence F1. The mask and the mask imaging lens are provided, for example, between the dichroic mirror 44 and the lens 51. Accordingly, in the flow cytometer 1b according to this embodiment with this configuration, the fluorescence F1 emitted from the cell C1 in response to irradiation of the cell C1 with the spotlight L2 by the illumination optical system 4b is applied to the mask via the mask imaging lens and is structured. Structuring an optical signal (that is, fluorescence F1) means modulating optical characteristics of the optical signal for each of a plurality of areas included in the incidence surface of the optical signal in the mask.

The mask used for the above structured detection is a spatial filter with a plurality of areas where light is incident on the surface of the mask. The plurality of areas of the mask include areas that transmit light (a light-transmitting area) and areas that block light (a light-blocking area), and the optical characteristics of the incident fluorescence F1 are modulated in each of the plurality of areas of the mask.

As another example, the detection optical system 5b may include mirrors which include light-transmitting areas and light-blocking areas and serving as a spatial filter, instead of the mask.

The mask imaging lens condenses the fluorescence F1 emitted from the cell C1 and focuses the fluorescence F1 on the mask. The light detector 6 detects fluorescence structured via the light-transmitting areas of the mask included in the detection optical system 5b.

When fluorescence is detected using the ghost cytometry technology, electronic data acquired by the signal intensity-acquiring unit 81 and indicating a time-series signal intensities of the structured fluorescence detected as a GMI signal by the light detector 6 is used for machine learning instead of the spectrum information A1. That is, in the flow cytometer 1b according to this embodiment, a trained model B1 for discrimination is generated through machine learning using training data where the electronic data indicating the signal intensities of fluorescence at each time point and identification information are combined. Moreover, in the flow cytometer 1b according to this embodiment, discrimination of the cell C1 is performed based on the trained model B1 and the electronic data indicating the time-series signal intensities of the fluorescent GMI signal detected from the cell C1 which is a measurement object.

In the flow cytometer 1b according to this embodiment, from the morphological information of measurement objects included in the GMI signals detected using the GMI method, morphological information whose resolution is higher than a predetermined resolution may be reconstructed as an image and used for discriminating the cell C1 . . . . The predetermined resolution differs depending on the wavelengths of illumination light, and the predetermined resolution is, for example about 0.5 μm. Similarly to the flow cytometer 1a according to the second embodiment, the flow cytometer 1b according to this embodiment can be configured to perform detection of fluorescence F1 as a GMI signal using the ghost cytometry technology at the same time as detection of scattered light other than the fluorescence F1.

### Conclusions of Embodiments

As described above, the flow cytometer 1, 1a, or 1b according to the aforementioned embodiments includes the flow channel 20, the light source 3, the illumination optical system 4, the detection optical system 5 or 5b, the light detector 6 and the discrimination unit 83.

The flow channel 20 allows a measurement object (the cell C1 in the embodiments) not labeled with a fluorescent dye to flow along with a fluid.

The light source 3 emits illumination light L1.

The illumination optical system 4, 4a, or 4b makes illumination light L1 emitted from the light source 3 into the spotlight L2, which is illumination light condensed in at least one of the width direction and the depth direction of the flow channel 20, to irradiate a measurement object (the cell C1 in the embodiments) flowing in the flow channel 20 at the irradiation position in the flow channel 20.

The light detector 6 or 6b detects fluorescence F1 emitted from a molecule specific to the measurement object (the cell C1 in the embodiments) in response to irradiation of the spotlight L2 by the illumination optical system 4, 4a, or 4b.

The detection optical system 5 or 5b causes the fluorescence F1 to propagate to the light detector 6 or 6b.

The discrimination unit 83 discriminates whether the measurement object (the cell C1 in the embodiments) is a target measurement object based on information (spectrum information A1 or signal intensities of the fluorescence F1 in the embodiments) of the fluorescence F1 detected by the light detector 6 or 6b.

With this configuration, the flow cytometer 1, 1a, or 1b according to the embodiments can improve sensitivity to the intensity of fluorescence F1 which is autofluorescence by irradiating a measurement object flowing in the flow channel 20 with the spotlight L2 condensed in at least one of the width direction and the depth direction of the flow channel 20, and thus it is possible to discriminate the measurement object based on autofluorescence in measurement using the flow cytometer.

The flow cytometer according to the embodiments may have a function of a cell sorter. The flow cytometer sorts cells based on information indicating morphology of the cells included in the optical information generated by the information processing device 8. Sorting means separating a target measurement object from measurement objects flowing in a flow channel. The target measurement object is, for example, selected by a user in advance.

When the flow cytometer has the function of a cell sorter, the flow cytometer includes, for example, a separation unit. The separation unit separates a target measurement object from measurement objects flowing in the flow channel 20. The separation unit separates a target measurement object based on the discrimination result from the discrimination unit 83.

Some or all of the functions of the information processing device 8 according to the embodiments may be provided in an external information processing device separate from the information processing device 8. The external information processing device is, for example, a PC which is separate from the information processing device 8. Some or all of the functions of the information processing device 8 may be provided in a cloud server.

The flow cytometer according to the aforementioned embodiments may be configured to switch between a low-speed mode in which autofluorescence is detected and a high-speed mode in which the type of light other than autofluorescence is detected. For example, in the low-speed mode in which autofluorescence is detected, the microfluidic device 2 controls a flow speed of a fluid flowing in the flow channel 20 such that it is lower than a predetermined speed (for example, 5 m/s). In the high-speed mode in which the type of light other than autofluorescence is detected, the microfluidic device 2 controls the flow speed such that it is equal to or higher than the predetermined speed.

Switching between the low-speed mode and the high-speed mode is performed, for example, by a user's operation via an input device. The operation is received by the information processing device 8, and the microfluidic device 2 is controlled by the information processing device 8.

In the aforementioned embodiments, the configuration of the flow cytometer capable of discriminating a measurement object based on autofluorescence has been mainly described, and a discrimination method in which data indicating intensities of autofluorescence of a measurement object is acquired based on the configuration of such a flow cytometer, information of autofluorescence of the measurement object is generated based on the acquired data, and whether the measurement object is a target measurement object or not is discriminated based on the generated information of autofluorescence of the measurement object is also included in the scope of the present invention.

### EXAMPLES

An example relating to the aforementioned embodiments will be described below.

### Method for the Preparation of Measurement Objects

In this example, as measurement objects, lymphocytes (T cells, B cells, and natural killer cells (NK cells)) separated from frozen human peripheral blood mononuclear cells were used without labeling with a fluorescent pigment or a fluorescent dye. After that, binary classification between two different types of cells were performed based on autofluorescence emitted from the cells and the classification accuracy was experimentally validated.

### Cell Processing

Lymphocytes (T cells, B cells, and NK cells) were separated from frozen human peripheral blood mononuclear cells (manufactured by STEMCELL Technologies, Inc.) using MACS Microbeads (Pan T cell Isolation Kit, NK Cell Isolation Kit, B cell Isolation Kit of Miltenyi Biotec, Inc.), were cleaned, and were adjusted to be 1×10⁴ cells/ml in a phosphate-buffered saline (also referred to as a PBS solution). A portion of the sample was taken from each of the purified lymphocyte samples for staining with fluorescence-labeled antibodies (FITC-labeled anti-human CD3 antibody, PE-labeled anti-human CD19 antibody, APC-labeled anti-human CD56 antibody manufactured by BioLegend, Inc.) and the purity of the purified lymphocyte samples was checked using an Attune NXT Flow Cytometer (manufactured by Thermo Fisher Scientific, Inc.). As a result, the purity of the lymphocytes included in each adjusted lymphocytic sample was 99.3% in T cells, 98.2% in B cells, and 93.9% in NK cells.

### Measurement of Autofluorescence

A flow cytometer 1a1 was used to discriminate cell samples using autofluorescence. The configuration of the flow cytometer 1a1 was based on the configuration of the flow cytometer 1a described above in the second embodiment. In the flow cytometer 1a1, the light source included a plurality of light sources. The flow cytometer 1a1 was different from the flow cytometer 1a (in which the light source includes a single light source) in the configuration of the light source, but was the same in other configurations.

In the flow cytometer 1a1, the light source included a plurality of laser light sources emitting illumination light of different wavelengths. The light source included a light source for measuring fluorescence and a light source for measuring scattered light. A laser light source emitting illumination light of a wavelength 360 nm and a laser light source emitting illumination light of a wavelength 375 nm were used as the light source for measuring fluorescence. A laser light source emitting illumination light of 405 nm was used as the light source for measuring scattered light.

In the flow cytometer 1a1, illumination light was condensed such that a spotlight at the irradiation position in the flow channel had a width of less than 10 μm in the width direction of the flow channel and a width of less than 1 μm in the depth direction of the flow channel. In the flow cytometer 1a1, a multi-anode PMT (manufactured by Hamamatsu photonics K.K.) was used as the light detector for detecting autofluorescence. From the fluorescence incident on the objective lens, light of a wavelength equal to or greater than 420 nm, which is obtained by cutting off light of a wavelength equal to or less than 420 nm using a dichroic mirror, was acquired as autofluorescence derived from the cells. Here, fluorescence excited in response to excitation light of a wavelength of 360 nm and fluorescence excited in response to excitation light of a wavelength of 375 nm were divided and separated in 15 channels by the multi-anode PMT.

In the flow cytometer 1a1, cells which were measurement objects were caused to converge to the vicinity of the center of the flow channel using acoustic focusing, a fluid in which the cells were dispersed was allowed to flow at a flow speed of 0.5 ml/min (to 50 cps), and fluorescence derived from the cells was measured simultaneously with scattered light (BSC).

### Discrimination of Cells

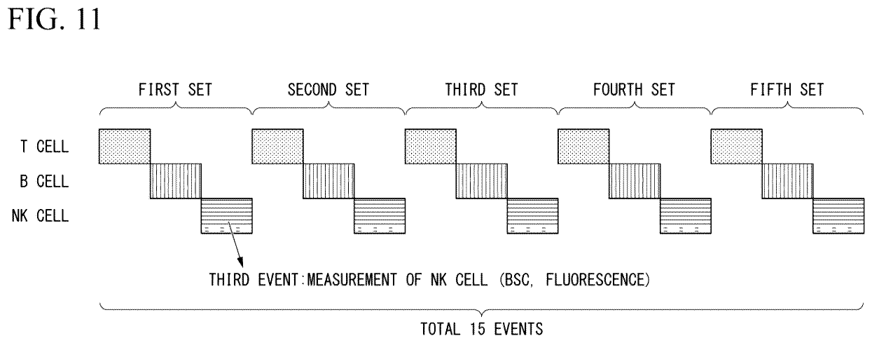

FIG. 11 is a diagram illustrating clusters of measurement results according to this example. As described above, in this example, three types of lymphocytes (T cells, B cells, and NK cells) were used as measurement objects, and measurement was continuously and repeatedly performed thereon.

Clusters (groups) of multiple measurements will be described below with reference to FIG. 11. In this example, measurements of each type of lymphocytes were continuously performed for about 30,000 to 40,000 cells. One cluster of measurements (30,000 to 40,000 times) continuously performed for one type of lymphocytes is referred to as an event in the following description. In this example, measurements were performed continuously in the order of T cells, B cells, and NK cells, and a cluster of measurements including three events performed continuously for three types of lymphocytes is referred to as a set in the following description.

In this example, as illustrated in FIG. 11, 5 sets of measurements from a first set to a fifth set were continuously performed. Since one event for each of three types of lymphocytes is included in each set, the 5 sets include a total of 15 events.

In each event, fluorescence information and scattered light (BSC) information were acquired as measurement data for each cell. As illustrated in FIG. 11, for example, in the third event, fluorescence information and scattered light information for NK cells were acquired.

In this example, for the fluorescence information, the feature values for each excitation wavelength were obtained by normalizing the total amounts of fluorescence intensities acquired in the individual channels for each of the excitation wavelengths with the maximum total amount of fluorescence intensities acquired for each of the excitation wavelengths and the feature values were used to discriminate the lymphocytes which will be described below. 15×2 pieces of feature values (corresponding to 15 channels of the multi-anode PMT for each of excitation light of 360 nm and excitation light of 375 nm) for the normalized fluorescence information and one piece of feature values for BSC were used for training and validation between the lymphocytes which will be described below.

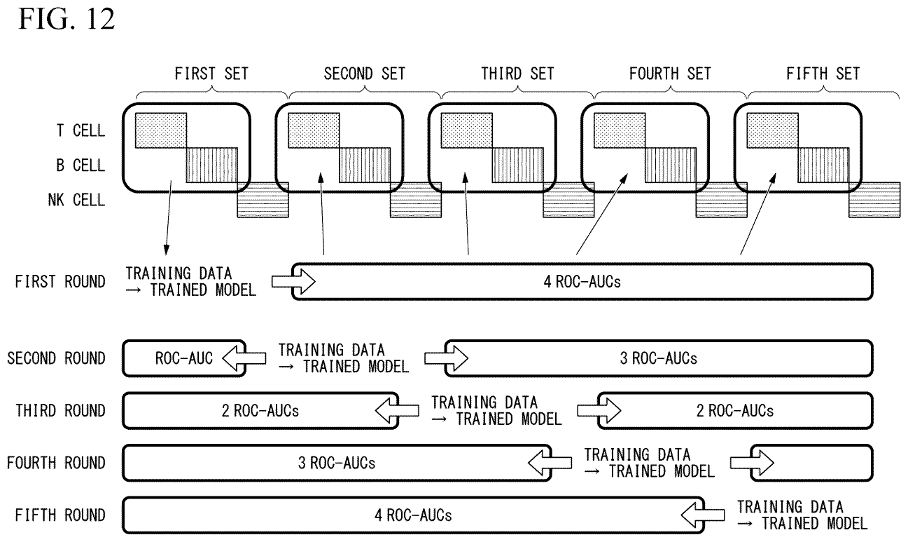

Discrimination between the lymphocytes was binary classification of classifying two specific types of lymphocytes into 2 classes. FIG. 12 is a diagram illustrating the method for discriminating between the lymphocytes according to this example. In FIG. 12, for example, it was assumed that binary classification was performed on T cells and B cells. In discriminating specific two types of lymphocytes, a classifier was generated using the measurement data for the two types of cells, which was acquired from one set out of the measurement data from the first set to fifth set, as training data. Then, the measurement data for the same two cell types acquired from other four sets were used as validation data, and discrimination was performed using the generated classifier for validation. This series of procedures was repeatedly performed while changing a training data set used to generate a classifier. The unit of this repetition is referred to as a round in the following description.

For example, in FIG. 12, in the first round validation, a classifier was generated using measurement data for T cells and B cells measured in the first set as training data. For the classifier generated using the measurement data of the first set as training data, validation of the discrimination performance using data of T cells and B cells measured in the second to fifth sets as validation data was carried out for each set (each of the second to fifth sets). Here, the data of two types of lymphocytes used as training data was the same for the types of lymphocytes as the data of two types of lymphocytes used as the validation data.

Additionally, in the validation of second to fifth rounds, for a classifier which was generated using the measurement data acquired in each of other four sets (from the second set to fifth set) as training data, discrimination was similarly repeated using the measurement data acquired in the other sets as validation data.

As described above, in this example, a total of 20 ROC-AUC values were calculated in a crossover design to discriminate between specific two types of lymphocytes, and accuracy of binary classification for the two types of lymphocytes was evaluated using an average value thereof. A random forest algorithm was used to generate the classifier.

### Discrimination Results

As a result of discrimination between lymphocytes, the following values were acquired as an average value (an AUC value) of ROC-AUC values for binary classification of T cells, B cells, and NK cells. The AUC value in the discrimination between T cells and B cells was 0.87, the AUC value in the discrimination between T cells and NK cells was 0.90, and the AUC value in the discrimination between B cells and NK cells was 0.95. On the other hand, when the same evaluation was performed on the two set of measurement data (normalized fluorescence information and BSC information) for which the measurements were made for the same cell types at close time intervals, the AUC value was calculated to be about 0.5. It was seen from the AUC values that measuring errors were sufficiently small.

As described above, it was confirmed from the results of this example that high classification accuracy (accuracy of binary classification for two specific types of lymphocytes) was obtained for any two types of cells between T cells, B cells, and NK cells through measurement using autofluorescence.

Part of the control unit 80 provided in the information processing device 8 according to the aforementioned embodiments, for example, the signal intensity-acquiring unit 81, the spectrum information-generating unit 82, the discrimination unit 83, and the learning unit 84, may be realized by a computer. In this case, these control functions may be realized by recording a program for realizing the control functions on a computer-readable recording medium and causing a computer system to read and execute the program. The “computer system” mentioned herein is a computer system provided in the information processing device 8 and includes an OS or hardware such as peripherals. The “computer-readable recording medium” means a portable medium such as a flexible disk, a magneto-optical disc, a ROM, or a CD-ROM or a storage device such as a hard disk incorporated into the computer system. The “computer-readable recording medium” may include a medium that dynamically holds a program in a short time such as a communication line when the program is transmitted via a network such as the Internet or a communication circuit line such as a telephone line. In that case, the “computer-readable recording medium” may include a medium that holds a program for a predetermined time such as a volatile memory in a computer system serving as a server or a client. The above program may be for realizing some of the aforementioned functions. The program may be a program for realizing the aforementioned functions in combination with a program recorded in advance in the computer system.

Some or all functions of the information processing device 8 according to the aforementioned embodiments may be realized as an integrated circuit such as a large-scale integration (LSI) circuit. Each of the functional blocks of the information processing device 8 may be implemented as individual processors, or some or all thereof may be integrated and implemented as a processor. The integration method is not limited to LSI and may be realized using a dedicated circuit or a general-purpose processor. When a technique for integration in place of LSI becomes available with advancement in semiconductor technology, an integrated circuit based on the technique may be used.

While embodiments of the present invention have been described above in detail with reference to the drawings, any specific configuration is not limited to the above description, and various modifications in design or the like can be made to the embodiments without departing from the gist of the present invention.

### Reference Number List

1, 1a, 1b . . . Flow cytometer
20 . . . Flow channel
3 . . . Light source
4, 4a, 4b . . . Illumination optical system
5, 5b . . . Detection optical system
6, 6b . . . Light detector
83 . . . Discrimination unit
C1 . . . Cell
L1 . . . Illumination light
L2 . . . Spotlight
F1 . . . Fluorescence
SP1 . . . Spectrum component
A1 . . . Spectrum information
B1 . . . Trained model

1. A flow cytometer comprising:
a flow channel allowing a measurement object not labeled with a fluorescent dye to flow along with a fluid;
a light source emitting illumination light;
an illumination optical system irradiating the measurement object flowing in the flow channel with the illumination light emitted from the light source as a spotlight which is illumination light condensed in at least one of a width direction and a depth direction of the flow channel at an irradiation position in the flow channel;
a light detector detecting fluorescence emitted from a specific molecule of the measurement object in response to irradiation with the spotlight via the illumination optical system;
a detection optical system allowing the fluorescence to propagate to the light detector; and
a discrimination unit configured to discriminate whether the measurement object is a target measurement object based on information of the fluorescence detected by the light detector.

2. The flow cytometer according to claim 1, wherein the illumination optical system irradiates the measurement object flowing in the flow channel with the spotlight by condensing the illumination light emitted from the light source to the size of the measurement object at the irradiation position.

3. The flow cytometer according to claim 1, further comprising a focusing mechanism configured to cause a sample flow of the measurement object flowing in the flow channel to converge to a predetermined range in the width direction of the flow channel, wherein the illumination optical system sets a ratio of a width of the spotlight to a width of the flow channel to be equal to or less than a predetermined ratio and irradiates the measurement object with the spotlight at the irradiation position.

4. The flow cytometer according to claim 1, further comprising a focusing mechanism configured to cause a sample flow of the measurement object flowing in the flow channel to converge to a predetermined range in the depth direction of the flow channel,
wherein the illumination optical system condenses the spotlight into a specific position in the depth direction of the flow channel and irradiates the measurement object with the spotlight at the irradiation position.

5. The flow cytometer according to claim 1, wherein the flow channel allows the measurement object to flow along with a fluid at a speed less than a predetermined speed.

6. The flow cytometer according to claim 1, wherein the detection optical system separates the fluorescence into spectrum components,
wherein the light detector detects each spectrum component of the fluorescence which is separated into the spectrum components by the detection optical system, and
wherein the discrimination unit performs the discrimination of the measurement object based on spectrum information which is information of the spectrum components of the fluorescence detected by the light detector.

7. The flow cytometer according to claim 6, further comprising a learning unit configured to generate a trained model for discriminating whether the measurement object is a target measurement object when the spectrum information on the measurement object is input,
wherein the discrimination unit performs the discrimination of the measurement object based on the spectrum information of the measurement object using the trained model.

8. The flow cytometer according to claim 7, wherein the learning unit generates the trained model by performing machine learning using training data in which the information of the spectrum components detected by the light detector and information for identifying the target measurement object are combined for a training sample including the target measurement objects and measurement objects other than the target measurement objects as the measurement objects, and
wherein the discrimination unit performs the discrimination of the measurement object based on the trained model generated by the learning unit and information of the spectrum components detected by the light detector for the measurement object flowing in the flow channel.

9. The flow cytometer according to claim 1, wherein at least one of the illumination optical system and the detection optical system includes a spatial light modulator,
wherein the light detector detects the fluorescence as a dynamic ghost imaging signal, and
wherein the discrimination unit performs the discrimination of the measurement object using morphological information with a higher resolution than a predetermined resolution out of morphological information of the measurement object included in the dynamic ghost imaging signal.

10. The flow cytometer according to claim 9, further comprising a learning unit configured to generate a trained model for discriminating whether the measurement object is the target measurement object when the dynamic ghost imaging signal for the measurement object is input,
wherein the discrimination unit performs the discrimination of the measurement object based on the dynamic ghost imaging signal for the measurement object using the trained model.

11. A discrimination method of discriminating a measurement object based on a result detected by a flow cytometer including:
a flow channel allowing a measurement object not labeled with a fluorescent dye to flow along with a fluid;
a light source emitting illumination light;
an illumination optical system irradiating the measurement object flowing in the flow channel with the illumination light emitted from the light source as a spotlight which is illumination light condensed in at least one of a width direction and a depth direction of the flow channel at an irradiation position in the flow channel;
a light detector detecting fluorescence emitted from a specific molecule of the measurement object in response to irradiation with the spotlight via the illumination optical system; and
a detection optical system allowing the fluorescence to propagate to the light detector, the discrimination method comprising:
an acquisition step of acquiring data indicating an intensity of the fluorescence detected by the light detector for the measurement object flowing in the flow channel;
a generation step of generating information of the fluorescence based on the data acquired in the acquisition step; and
a discrimination step of discriminating whether the measurement object is a target measurement object based on the information of the fluorescence generated in the generation step.

12. A program causing a computer to perform information processing based on a result detected by a flow cytometer including:
a flow channel allowing a measurement object not labeled with a fluorescent dye to flow along with a fluid;
a light source emitting illumination light;
an illumination optical system irradiating the measurement object flowing in the flow channel with the illumination light emitted from the light source as a spotlight which is illumination light condensed in at least one of a width direction and a depth direction of the flow channel at an irradiation position in the flow channel;
a light detector detecting fluorescence emitted from a specific molecule of the measurement object in response to irradiation with the spotlight via the illumination optical system; and
a detection optical system allowing the fluorescence to propagate to the light detector, the computer performing:
an acquisition step of acquiring data indicating an intensity of the fluorescence detected by the light detector for the measurement object flowing in the flow channel;
a generation step of generating information of the fluorescence based on the data acquired in the acquisition step; and
a discrimination step of discriminating whether the measurement object is a target measurement object based on the information of the fluorescence.
